(19) United States
(12) Patent Application Publication
(10) Pub. No.: US 2005/0233208 A1
(43) Pub. Date: Oct. 20, 2005

(54) 4.5V battery cartridge

(76) Inventor: Shu-Lien Tang, Taipei (TW)

Correspondence Address: Tang, Shu-Lien, 7F., No. 213, Civic Boulevard. Sec. 4, Taipei, 105, TW

(21) Appl. No.: 10/827,407

(22) Filed: Apr. 17, 2004

(51) Int. Cl. H01M 2/02; H01M 2/08; H01M 2/24; H01M 2/30

(52) U.S. Cl. 429/159; 429/174; 429/181

(57) ABSTRACT

A 4.5V battery cartridge includes a cylindrical container having an open end closed with a cover, at the same side of which a first and a second contact electrode are provided; and three pieces of 1.5V batteries mounted in the cylindrical container and connected in series via first conductors. One of the three 1.5V batteries is connected at a negative electrode to the first contact electrode via a second conductor, and another one of the three 1.5V batteries is connected at a positive electrode to the second contact electrode via a third conductor, such that the first and the second contact electrode are defined as negative and positive electrode, respectively. The 4.5V battery cartridge enables multiple batteries having lower voltage to be connected in series to supply required 4.5V power.

### FIELD OF THE INVENTION

The present invention relates to a 4.5V battery cartridge, and more particularly to a 4.5V battery cartridge that enables a plurality of batteries having lower voltage to be connected in series in the cartridge to supply power having higher voltage.

### BACKGROUND OF THE INVENTION

The general commercially available dry batteries typically have a voltage of 1.5V, no matter in what size they are. When an electric appliance to be used requires a higher voltage, such as 3V, 4.5V, 6V, or 7.5V, a battery compartment for receiving batteries would usually be provided on the electric appliance by the manufacturer of the appliance. The battery compartment is large enough for receiving two batteries, provided the required voltage of the appliance is 3V; or three batteries, provided the required voltage is 4.5V; or four batteries, provided the required voltage is 6V; or five batteries, provided the required voltage is 7.5V. Therefore, different sets of molds must be prepared for forming differently sized battery compartments for the same type of electric appliance, resulting in increased time, procedures, and cost in manufacturing the appliance.

In the event a user desires to increase the battery voltage to the required voltage of the electric appliance, for example, from 1.5V to 4.5V, he would usually connect three batteries in series using conductors and connect the serially connected batteries to the electric appliance using another conductor. Since there is not any means ready for holding the serially connected batteries, the user would usually bind the batteries together by winding a tape around the batteries. The serially connected and tape-bound batteries are exposed from the electric appliance. The tape-bound batteries would cause inconveniences in replacing the batteries, and have adverse influence on the appearance of the electric appliance. Thus, the general 1.5V batteries do not always meet the consumer's requirements.

Moreover, general integrated circuits (IC) and light-emitting diodes (LED) have a working voltage within the range from 2.2V to 5V. These devices could not be driven to work if an input voltage designed for these circuits was too low. On the other hand, an exceedingly high input voltage must be lowered to meet the required working voltage. Therefore, it is desirable to develop a new way to utilize the existing 1.5V battery cells to power an electric appliance without the problem of increasing or lowering the voltage.

### SUMMARY OF THE INVENTION

A primary object of the present invention is to provide a battery cartridge that enables a plurality of batteries having lower voltage to be connected in series in the cartridge to supply power having higher voltage of 4.5V.

To achieve the above and other objects, the present invention provides a 4.5V battery cartridge that includes a cylindrical container having an open end closed with a cover, at the same side of which a first and a second contact electrode are provided; and three pieces of 1.5V batteries mounted in the cylindrical container and connected in series via first conductors. One of the three 1.5V batteries is connected at a negative electrode to the first contact electrode via a second conductor, and another one of the three 1.5V batteries is connected at a positive electrode to the second contact electrode via a third conductor, such that the first and the second contact electrode are defined as negative and positive electrode, respectively. The 4.5V battery cartridge enables multiple batteries having lower voltage to be connected in series to supply required 4.5V power.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a 4.5V battery cartridge according to the present invention;

FIG. 2 is a partially assembled perspective view of FIG. 1;

FIG. 3 is an assembled sectional view of the 4.5V battery cartridge of the present invention; and

FIG. 4 is a circuit diagram for the 4.5V battery cartridge of the present invention.

### DETAILED DESCRIPTION OF THE PREFERRED EMBODIMENTS

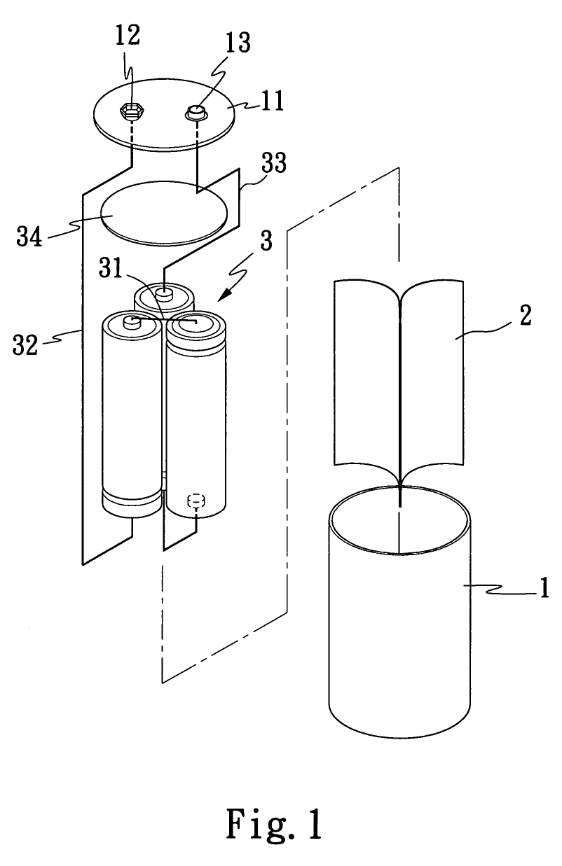

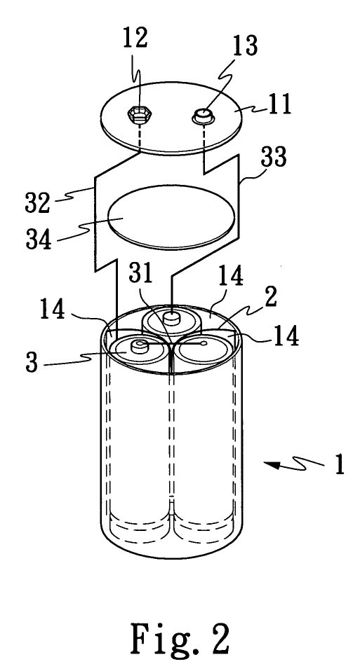

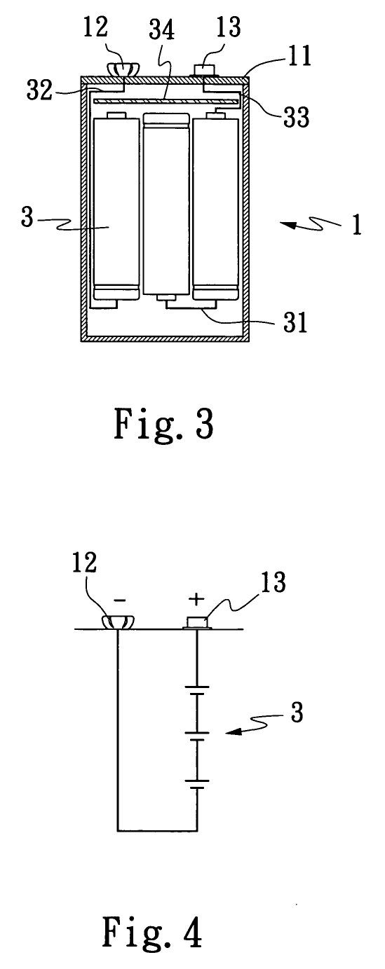

Please refer to FIGS. 1, 2, 3, and 4, in which a 4.5V battery cartridge according to the present invention is shown. As shown, the 4.5V battery cartridge of the present invention mainly includes a cylindrical container 1, a partition 2, and three pieces of 1.5V batteries 3. The 4.5V battery cartridge of the present invention enables multiple pieces of batteries having lower voltage to be connected in series therein to supply required higher power.

The cylindrical container 1 includes an open end that is closed with a cover 11. A first and a second contact electrode 12, 13 are provided at the same side of the cover 11.

The partition 2 is positioned in the cylindrical container 1, and made of thin sheet plastics. The partition 2 is properly bent and curved to have curvatures corresponding to circumferential surfaces of the batteries 3 held in the container 1, so that an internal space defined by the container 1 is divided into multiple receiving rooms 14.

The three pieces of 1.5V batteries 3 are separately positioned in the receiving rooms 14. The 1.5V batteries are electrically connected in series using first conductors 31, each of which connects a positive electrode and a negative electrode of two different batteries. One of the three 1.5V batteries 3 is electrically connected at a negative electrode to the first contact electrode 12 via a second conductor 32, and a second one of the 1.5V batteries 3 is electrically connected at a positive electrode to the second contact electrode 13 via a third conductor 33, so that the first and the second contact electrode 12, 13 are defined as negative and positive electrode, respectively. When the first and the second contact electrode 12, 13 are connected to a desired electric appliance (not shown), power is supplied from the batteries 3 to the electric appliance. Moreover, an insulating plate 34 is located between the cover 11 and the three 1.5V batteries 3.

In the event a user wants to use an electric appliance that requires a voltage of 4.5V, the user may mount three 1.5V batteries 3 in the container 1 with the first conductors 31 electrically connecting the positive electrode of one battery 3 to the negative electrode of another battery 3, so that the three 1.5V batteries 3 are connected in series in the container 1, and the second conductors 32, 33 electrically connecting a negative and a positive electrode, respectively, of two of the batteries 3, which are not connected to the first conductors 31, to the first and the second contact electrode 12, 13, respectively. In this manner, the first and the second contact electrode 12, 13 are defined as negative and positive electrodes, respectively, via which power may be supplied from the serially connected 1.5V batteries to the desired electric appliance. In brief, multiple 1.5V batteries 3 mounted in the container 1 may be connected in series via the conductors 31, 32, and 33 to form a battery cartridge providing the required voltage of 4.5V.

The above-structured 4.5V battery cartridge allows multiple batteries of lower voltage mounted therein to connect in series to supply power with required higher voltage of 4.5V and effectively eliminates drawbacks existed in the conventional ways of providing power of 4.5V.

The present invention has been described with a preferred embodiment thereof and it is understood that many changes and modifications in the described embodiment can be carried out without departing from the scope and the spirit of the invention that is intended to be limited only by the appended claims.

1. A 4.5V battery cartridge, comprising:
a cylindrical container having an open end being closed with a cover, said cover being provided at the same side with a first and a second contact electrode; and
three pieces of 1.5V batteries being mounted in said cylindrical container and connected in series via first conductors; and one of said three 1.5V batteries being connected at a negative electrode to said first contact electrode via a second conductor, and another one of said three 1.5V batteries being connected at a positive electrode to said second contact electrode via a third conductor, such that said first and said second contact electrode are defined as negative and positive electrode, respectively.

2. The 4.5V battery cartridge as claimed in claim 1, further comprising an insulating plate located between said cover and said three pieces of 1.5V batteries.

3. The 4.5V battery cartridge as claimed in claim 1, further comprising a partition positioned in said container to divide an internal space defined by said container into a plurality of receiving rooms.

4. The 4.5V battery cartridge as claimed in claim 3, wherein said partition is made of thin sheet plastics, which is bent and curved to have curvatures corresponding to circumferential surfaces of batteries to be mounted in said container.
